(19) United States
(12) Patent Application Publication
(10) Pub. No.: US 2003/0065909 A1
(43) Pub. Date: Apr. 3, 2003

(54) Deferral of dependent loads until after execution of colliding stores

(76) Inventor: Stephan J. Jourdan, Portland, OR (US)

Correspondence Address: KENYON & KENYON, 1500 K STREET, N.W., SUITE 700, WASHINGTON, DC, 20005, US

(21) Appl. No.: 09/964,807

(22) Filed: Sep. 28, 2001

(51) Int. Cl. G06F 9/30

(52) U.S. Cl. 712/216

(57) ABSTRACT

In a scheduler, dependencies between newly received load microinstructions and older store microinstructions are predicted. If a dependency is predicted, the load microinstruction is stored in the scheduler with a marker to indicate that scheduling of the load microinstruction is to be deferred. The marker may be cleared when the colliding store, the store that caused the dependency, has executed.

### BACKGROUND

The present invention is related generally to scheduling of load microinstructions within processors and other computing agents. More specifically, it is related to scheduling of load microinstructions when dependencies are predicted to exist between the load microinstructions and store microinstructions in program flow.

“Store forwarding” refers generally to a scheduling technique in processors in which, when a dependency is found to exist between a load instruction and an earlier store instruction, data for the load instruction is taken from a store unit associated with the earlier store rather than from main memory or a cache. In this way, store forwarding attempts to ensure that the load instruction acquires the most current copy of data available.

Although implementations vary, store forwarding typically involves comparing an address of the load instruction with addresses of all older store instructions available in the store unit. The comparison may result in one or more matches. The load instruction acquires data of the youngest matching store instruction and causes it to be written to an associated register.

In practice, an execution unit, where the store unit and load unit reside, operates on microinstructions (colloquially, “uops”) rather than instructions themselves; instructions are decoded into microinstructions before they are input to the execution unit. A store instruction may be decoded into plural uops including an “STA” uop that, when executed, computes an address of a memory location where data should be stored and an “STD” uop that, when executed, writes to the store unit the data to be stored in memory. Retirement of the STD causes the data to be written from the store unit to the memory location.

The inventor determined that store forwarding can impair system performance in certain circumstances. Oftentimes, in the STA-STD system described above, a load uop may execute before execution of one or more older STD uops. It is possible that store forwarding will cause a load to acquire garbage data from the store unit (or from memory) because the STD will not have executed. In this case, all uops that depend on the load uop may execute, again with incorrect data. These uops will have to re-execute once, possibly multiple times, until correct data is available to the load uop. The bandwidth consume by the unnecessary execution of these uops can impair system performance. Other uops could have been executed instead and may have generated useful results.

Accordingly, there is a need in the art for a scheduler that identifies load-store dependencies and schedules execution of a dependent load uop only after a colliding STD uop has executed.

### BRIEF DESCRIPTION OF THE DRAWINGS

FIG. 1 is a partial block diagram of an execution unit of a processing system.

FIG. 2 is a flow diagram of a method according to an embodiment of the present invention.

FIG. 3 is a flow diagram of another method according to an embodiment of the present invention.

FIG. 4 is a block diagram of an entry for a scheduler when storing a load uop, according to an embodiment of the present invention.

### DETAILED DESCRIPTION

Embodiments of the present invention provide a scheduler that predicts addressing collisions between newly received load microinstructions and older store microinstructions. If a collision is predicted, the load microinstruction is stored in the scheduler with a marker that indicates scheduling of the load microinstruction should be deferred. The marker may be cleared when data for the colliding store, the store that caused the collision, has been acquired. A load uop so stored will not be scheduled for execution until the marker is cleared. Other uops may be scheduled instead. In so doing, the embodiments conserve resources of the execution unit by causing other uops that are likely to generate useful results to be executed instead of the dependent load uop.

In an embodiment, a dependency pointer may be stored for a deferred load uop that points back to a colliding STD. Dependency pointers are known per se. Traditionally, they are used to identify dependencies among uops that can change data in a register file of an execution unit. Dependency pointers have not been considered for use with STD uops because they do not change data in a register file; STD uops fetch data from a register file and store them in a store unit. No known system uses a dependency pointer to point to an STD uop.

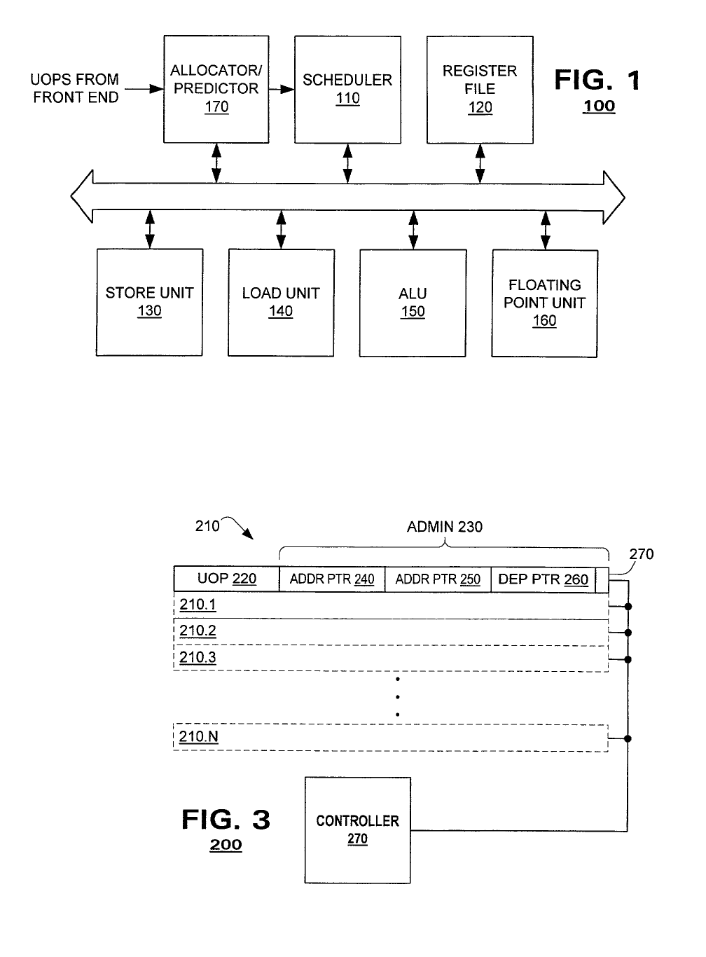

FIG. 1 is a partial block diagram of a conventional execution unit 100. The execution unit 100 may include an allocator 170, a scheduler 110, a register file 120 and one or more execution modules 130-160. In the exemplary execution unit 100 of FIG. 1, the execution modules include a store unit 130, a load unit 140, an arithmetic logic unit (“ALU”) 160 and a floating point unit 160. Other execution units 100 may include more or fewer execution modules according to design principles that are well known.

The decoded uops may be stored in the scheduler 110. Typically, the scheduler 110 stores the uops in program order. Thus, the scheduler 110 may distinguish between older uops, those received earlier in program order, and younger uops, those received later in program order.

As its name implies, having stored the decoded instructions, the scheduler 110 schedules each for execution by an execution module 130-160. A uop may be removed from the scheduler 100 after it has been executed.

The register file 120 is a pool of registers in which data can be stored upon execution of the uops. Typically, registers therein (not shown) are allocated for a uops when the uop is stored in the scheduler 110. Thereafter, when results of an microinstruction are generated by an execution module (say, ALU 150), the results may be stored in the allocated register in the register file 120.

The execution modules 130-160 are special application circuits devoted to processing specific uops. Allocated entries, such as the store unit entries and load unit entries discussed above, also may be allocated in program order. In this regard, the operation of execution units 100 is well known.

The allocator 170 may receive decoded uops from a front end unit (not shown) and allocate resources within the execution unit 100 to support them. For example, every uop is allocated an entry (not shown) within the scheduler 110 and perhaps an entry in the register file. Additionally, resources of the execution units may be allocated to a newly-received uop. For example STA and STD uops of a store instruction may be allocated an entry in the store unit 130; the pair typically shares a single entry in the store unit 130. Load uops may be allocated an entry in the load unit 140.

The allocator 170 may include prediction circuits devoted to prediction of dependencies between instructions, such as the load-store dependencies described above. When the allocator 170 determines that a new uop is likely to be dependent upon an older uop, the allocator 170 may store the uop in the scheduler 110 with an identifier of the uop on which it depends. For this purpose, the allocator 170 is labeled an “allocator/predictor,” for clarity. In certain embodiments, the allocator and prediction functions may be employed in an integrated circuit system, in others, they may be employed in separate circuit systems; for the purposes of the present invention, such distinctions are immaterial. Indeed, these units may be integrated or maintained separately from other execution unit element, such as the scheduler 110 as may be desired.

According to an embodiment, the allocator 170 may predict dependencies between load uops and an STA-STD uop pair. If a “collision” is predicted, if a dependency is determined to exist between a load uop and a STA-STD uop pair, the execution unit 100 may defer execution of the load uop until after the colliding STD uop executes. Thereafter, when the colliding STD uop executes, the deferred load uop may be scheduled for execution.

Detection of dependencies may be made according to any of the techniques known in the art. It is conventional to predict dependencies between load uops and STA uops. Some systems predicted a load uop to be dependent upon all older STA uops until the STA uops were executed and their addresses became available for a direct address comparison. Thereafter, dependencies could be identified. Other systems may operate according to a prediction scheme that assumes an STA and a load will not collide. In such systems, the load is permitted to execute as early as possible and is re-executed if a later continuity check determines that the prediction was made in error. Still other systems may use past predictions as a guide for new predictions. Any of these known techniques may be employed to create dependencies between load uops and STD uops. Having marked a load uop as deferred because of a colliding STA-STD pair, the deferral may be cleared once the STD uop executes.

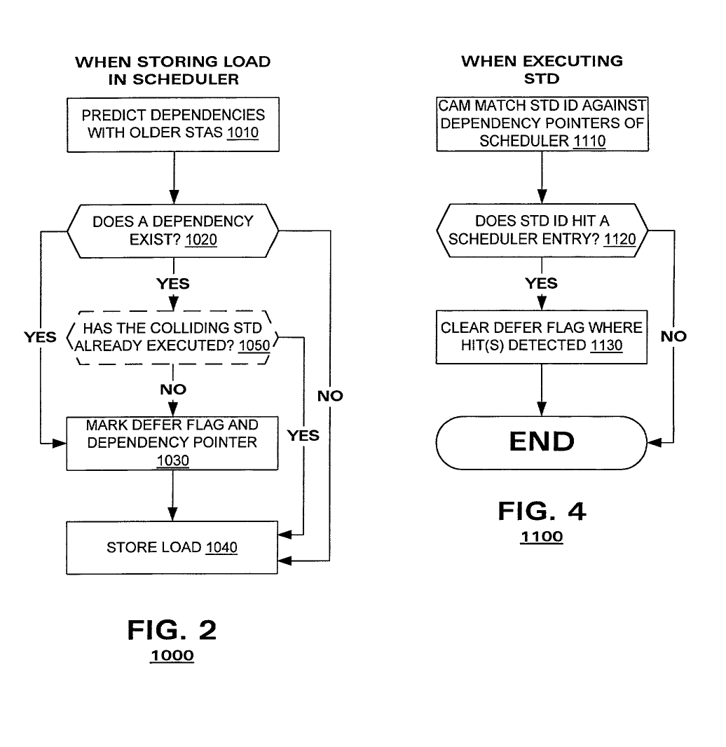

FIG. 2 is a flow diagram of a method 1000 operable when the execution unit 100 receives a new load uop according to an embodiment of the invention. According to the method 1000, a prediction may be made to determine whether the load uop is likely to collide with a previously stored STA-STD pair (box 1010). If a collision is predicted to occur, the load uop may be stored in the scheduler 110 with a marking to designate it as deferred and with an identifier of the colliding STD (boxes 1020, 1030). Otherwise, the load uop may be stored without marking it as being deferred (box 1040).

During operation, as the scheduler 110 reviews load uops and orders them for execution by the load unit 140 (FIG. 1), the scheduler 110 may skip a load uop that is marked as being deferred. Thus, a load uop for which an STD dependency is detected may be deferred until the dependency is cleared.

Optionally, after predicting a likely collision between the new load and an older STD, the method 1000 may determine if data for the STD has been written therein already (box 1050). If so, if data for the STD is already available in the store unit, the new load uop need not be marked as deferred.

FIG. 3 illustrates a method, in an embodiment, of clearing deferred load uops operable when an STD uop executes. When an STD uop executes, the scheduler may compare an identifier of the STD uop with dependency pointers of all uops stored by the scheduler (box 1110). If a match is detected, the scheduler may clear the dependency marker within a matching scheduler entry (boxes 1120, 1130). Thereafter, the method may terminate. When the marker of a previously deferred load uop is cleared, the load uops may be scheduled for execution according to the scheduler's normal processes.

As discussed above, a scheduler may store an identifier of an STD uop as a dependency pointer for a newly received load uop. Various embodiments of the STD identifier are possible, depending upon the implementation of the scheduler 110 and execution unit. In a first embodiment, the STD identifier simply may be an identifier of the scheduler location in which the STD uop is stored. In another embodiment, the STD identifier may be a store unit location in which the executed STD uop stored data. Either of these embodiments are appropriate for use with embodiments of the present invention.

FIG. 4 is a block diagram of an entry 210 for a scheduler 200 when storing a load uop according to an embodiment of the present invention. The scheduler entry 210 may include fields 220, 230 for storage of the load uop itself and for storage of administrative information to be used by the scheduler during the execution of the load uop. For example, the admin field 230 may store one or more pointers 240, 250 (typically two) identifying data to be used to calculate a memory address from which data is to be loaded. According to an embodiment, the admin field 230 of a load uop may be extended to include fields for storage of a dependency pointer 260 and a valid flag 270. The dependency pointer 260 may identify the STD on which the load uop depends. The state of the valid flag 270 may be tested to determined whether or not scheduling of the load uop is to be deferred.

Alternatively, in lieu of a valid flag 270, the scheduler 200 may permit values stored in a dependency pointer to take any value except one value that is reserved as an invalid value. To determine whether the load uop is dependent upon an unexecuted STD uop, the value of the dependency pointer 260 may be tested. If the value is valid, it indicates that the load uop should be deferred.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A scheduler, comprising a plurality of scheduler entries, wherein entries that store a load microinstruction include a first field for storage of microinstruction type data and an administrative field having at least one field to store address operand pointers and an additional field to store a dependency pointer.

2. The scheduler of claim 1, wherein the entries that store load microinstructions further comprise a field to store a valid bit associated with the dependency pointer.

3. The scheduler of claim 2, wherein a predetermined state of the valid bit in one of the entries indicates that scheduling of the load microinstruction in the one entry is to be deferred.

4. The scheduler of claim 1, wherein the presence of data in the dependency pointer in one of the entries indicates that scheduling of the load microinstruction in the one entry is to be deferred.

5. A scheduling method for a load microinstruction, comprising:
predicting a collision between a new load microinstruction and an older store microinstruction,
when a collision is detected, determining whether data for the older store microinstruction is available,
if data for the older store is not available, storing the load microinstruction in a scheduler with a marker indicating that scheduling of the load microinstruction is to be deferred.

6. The scheduling method of claim 5, further comprising storing a scheduler entry identifier of the older store with the load microinstruction.

7. The scheduling method of claim 5, further comprising scheduling the load microinstruction for execution after the marker is cleared.

8. The scheduling method of claim 7, further comprising scheduling other instructions dependent upon the load microinstruction to execute after the load microinstruction executes.

9. The scheduling method of claim 5, further comprising deferring scheduling of other instructions dependent upon the load microinstruction when scheduling of the load microinstruction is deferred.

10. The scheduling method of claim 5, wherein the store microinstruction part of a plurality of microinstructions representing a store instruction, wherein the first microinstruction is to transfer data to a store unit and a second microinstruction is to calculate an address of the store instruction.

11. The scheduling method of claim 10, further comprising clearing the marker of the load microinstruction after the first store microinstruction executes.

12. The scheduling method of claim 10, wherein the prediction determines a collision between the load microinstruction and the second store microinstruction.

13. An execution unit for a processing agent, comprising:
a scheduler operating according to the method of claim 5,
a register file, and
a plurality of execution modules,
wherein the scheduler, the register file and the execution modules each are coupled to a common communication bus.

14. A scheduling method, comprising:
predicting whether a new load microinstruction collides with a first previously received store microinstruction,
when a collision is detected, storing the load microinstruction in a scheduler with a dependency pointer to a second previously received store microinstruction.

15. The scheduling method of claim 14, further comprising scheduling the load instruction for execution after the marker is cleared.

16. The scheduling method of claim 15, further comprising scheduling other instructions dependent upon the load instruction to execute after the load instruction executes.

17. The scheduling method of claim 14, further comprising deferring scheduling of other instructions dependent upon the load instruction when scheduling of the load instruction is deferred.

18. The scheduling method of claim 14, wherein the store microinstruction part of a plurality of microinstructions representing a store instruction, wherein the first microinstruction is to transfer data to a store unit and a second microinstruction is to calculate an address of the store instruction.

19. The scheduling method of claim 18, further comprising clearing the marker of the load microinstruction after the first store microinstruction executes.

20. The scheduling method of claim 18, wherein the prediction determines a collision between the load microinstruction and the second store microinstruction.

21. An execution unit for a processing agent, comprising:
a scheduler operating according to the method of claim 14,
a register file, and
a plurality of execution modules,
wherein the scheduler, the register file and the execution modules each are coupled to a common communication bus.

22. A dependency management method, comprising, upon execution of a STD uop:
comparing an identifier of the STD uop to dependency pointers of other uops stored by a scheduler, and
clearing any dependency pointers that match the identifier.

23. The dependency management method of claim 15, wherein the identifier represents a location in the scheduler where the STD uop is stored.

24. The dependency management method of claim 15, wherein the identifier represents a location in a store unit where data responsive to the STD uop is stored.
